(19) United States
(12) Patent Application Publication
(10) Pub. No.: US 2005/0068856 A1
(43) Pub. Date: Mar. 31, 2005

(54) Method of on-line adjusting a sled motor control signal (FMO)

(75) Inventors: Jen-Yu Hsu, Taipei (TW); Hsiang-Yi Fu, Taipei (TW); Tun-Chieh Lee, Taipei (TW); Fu-Hsiang Chen, Taipei (TW); Yao-Chou Tsai, Taipei (TW)

Correspondence Address: BACON & THOMAS, PLLC, 625 SLATERS LANE, FOURTH FLOOR, ALEXANDRIA, VA, 22314, US

(73) Assignee: LITE-ON IT CORPORATION, Taipei (TW)

(21) Appl. No.: 10/949,215

(22) Filed: Sep. 27, 2004

(30) Foreign Application Priority Data
Sep. 29, 2003 (TW) 92126910

(51) Int. Cl. G11B 7/00

(52) U.S. Cl. 369/30.1; 369/44.28; 369/53.25

(57) ABSTRACT

A method of on-line adjusting a sled motor control signal (FMO) is disclosed. First, a predetermined FMO is assigned to move a sled for seeking, and a photo signal is monitored. The number of waveforms appearing in the photo signal and a distance from an optical pickup to a target track are calculated under this predetermined FMO. Then, the optical pickup is moved to the target track such that the optical pickup after seeking is located at a center position of a movable range. If the number of waveforms appearing in the photo signal is not equal to a predetermined number, the duration of the FMO is adjusted according to the difference therebetween.

This application claims the benefit of Taiwan application Serial No. 92126910, filed Sep. 29, 2003, the subject matter of which is incorporated herein by reference.

### BACKGROUND OF THE INVENTION

1. Field of the Invention

The invention relates in general to a method of on-line adjusting a sled motor control signal (FMO) in an optical disk drive during seeking, and more particularly to a method of moving an optical pickup to a center position of its movable range after seeking.

2. Description of the Related Art

Typically, as an optical disk drive receives a read or write command outputted from a host, its seeking servo firstly performs the seeking operation to move the optical pickup to a target track identified by the servo system. The seeking operations are usually divided into a long (rough) seeking operation and a short (fine) seeking operation. The distance of several hundreds of tracks is regarded as the short seeking operation, while the distance of several thousands of tracks is regarded as the long seeking operation. Taking 10,000 tracks as an example, the seeking servo firstly seeks 9500 tracks (long seeking), and then precisely controls the optical pickup to reach the target track according to the short seeking mechanism. Because the invention relates to the short seeking operation, the following description of the mechanism is made with respect to the short seeking operation.

FIG. 1 is a schematic illustration showing an optical pickup module. The optical pickup module 1 includes an optical pickup 3, a spring 5, a sled 7 and a laser diode (not depicted). When the distance to the target track is not long (e.g., the distance to the optical pickup 3 is only 100 tracks, and the short seeking is performed), the servo system only slightly adjusts the position of the optical pickup 3. The position adjustment is accomplished by the spring 5. The spring 5 only slightly moves the optical pickup 3, as shown in FIG. 1, according to the force coming from the tracking servo system. The servo system detects the position of the target track and then applies the force to the spring 5 to pull the optical pickup 3 to the target track.

After seeking, the optical pickup 3 is usually adjusted to a center position of the sled 7, as shown in FIG. 2(a). Because the track on operation is performed immediately after seeking, the time for track on is longer as the distance from the optical pickup 3 to the center position of the sled 7 is farther. In a serious condition, the track on operation may fail and the servo system cannot judge the position of the optical pickup 3 because the optical pickup 3 is out of the movable range above the sled. Thus, the servo system usually uses a FMO (sled motor control signal) to move the sled 7 during the short seeking and tracking processes, such that the optical pickup 3 is held within its movable range.

FMO is a force voltage for moving the sled 7. The relative position between the optical pickup 3 and the sled 7 is changed according to the movement of the sled 7 such that the position of the optical pickup 3 is within the movable range. How the FMO is utilized to adjust the position of the optical pickup and to keep the optical pickup within its movable range will be described in the following.

As shown in FIG. 2(a), the optical pickup 3 is at the center position of the sled 7. When the optical pickup 3 is performing the short seeking process, the servo system forces the spring 5 to move the optical pickup 3 for seeking in the direction 11. Because the optical pickup 3 is forced, the FMO also starts to force the sled 7, as shown in FIG. 2(b). However, the force of the FMO is insufficient to move the sled due to the relationship between the weight of the sled and the friction force. The optical pickup 3 continues seeking in the direction 11, and the position of the optical pickup 3 is much more deviated from the center position of the sled 7, as shown in FIG. 2(c). At this time, the optical pickup 3 is almost out of its movable range, and the force of the FMO is large enough to push the sled 7. So, the sled 7 is forced to move in the direction 11, and the optical pickup 3 is again back to the center position of the sled 7, as shown in FIG. 2(d). The above-mentioned steps are repeated to move the optical pickup 3 if the seeking process is to be performed continuously.

However, the difference between the dynamic friction force and the static friction force during seeking often causes the optical pickup to be out of the movable range of the sled when it reaches the target track.

As shown in FIG. 3(a), the optical pickup 3 is located at the center position of the sled 7. Because the seeking operation of, for example, 200 tracks, is to be performed, the optical pickup 3 is moved in the direction 11. The force outputting curve of the FMO is shown in FIG. 3(d). When the optical pickup 3 moves 100 tracks to be almost out of the movable range of the sled 7, as shown in FIG. 3(b), the FMO causes a force to be applied to the sled 7 such that the sled 7 is moved in the direction 11. However, because the static friction force of the sled 7 is larger than its dynamic friction force, the sled 7 over slides such that the optical pickup 3 is not at the center position of the sled 7. In a serious condition, the optical pickup 3 may be moved out of its movable range, as shown in FIG. 3(c).

The above-mentioned condition is very disadvantageous to the track on operation after seeking. Thus, much more time has to be spent to perform the track on operation or the track on operation may fail. Hence, the conventional optical disk drive needs a more effective method of controlling the FMO during the short seeking such that the optical pickup is located at the center position of the sled after seeking.

### SUMMARY OF THE INVENTION

It is therefore an object of the invention to provide a method of on-line adjusting a FMO in order to solve the problem that an optical pickup is out of a movable range after seeking.

The invention achieves the above-identified object by providing a method of on-line adjusting a FMO in an optical disk drive during seeking. First, a predetermined FMO is assigned to move a sled for seeking, and a photo signal is monitored. The number of waveforms appearing in the photo signal and a distance from an optical pickup to a target track are calculated under this predetermined FMO. Then, the optical pickup is moved to the target track such that the optical pickup after seeking is located at a center position of a movable range. If the number of waveforms appearing in the photo signal is not equal to a predetermined number, the duration of the FMO is adjusted according to the difference therebetween.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a schematic illustration showing an optical pickup module.

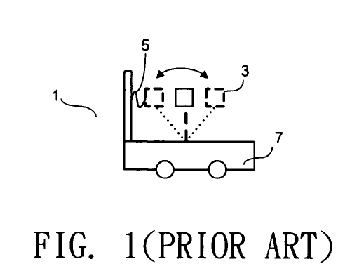

FIG. 2(a)˜2(d) is a schematic illustration showing the relative position between the optical pickup and the sled during the seeking process.

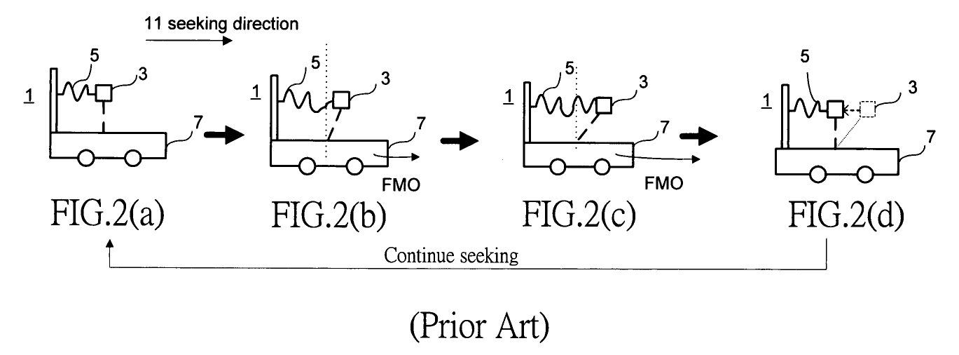

FIG. 3(a)˜3(d) is a schematic illustration showing the relative position between the optical pickup and the sled when the optical disk drive is seeking.

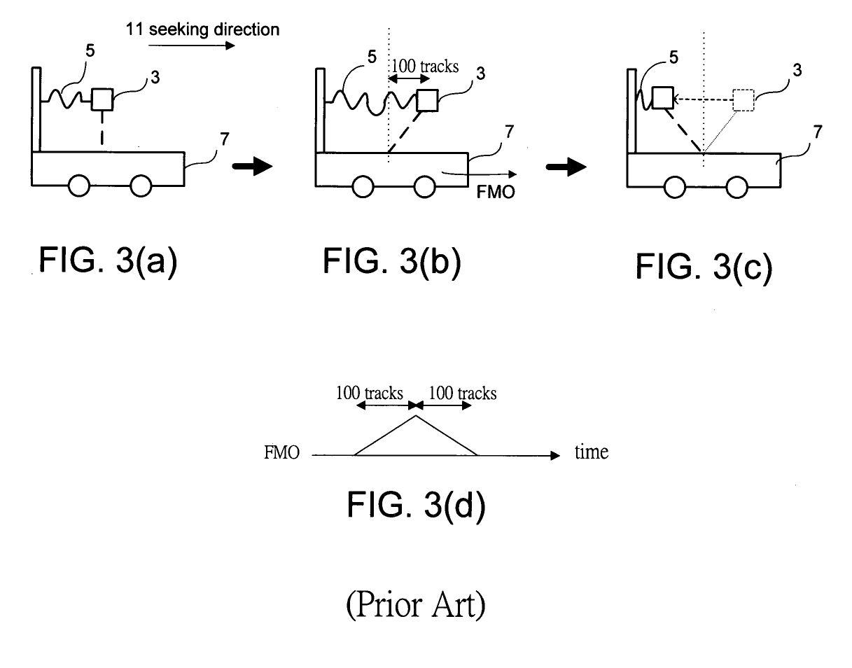

FIG. 4 is a schematic illustration showing a photo interrupt and a photo signal.

FIG. 5 is a schematic illustration showing a FMO and a photo signal of the invention.

FIG. 6 is a schematic illustration showing a force of the FMO to move the sled such that the waveform appears once in the photo signal.

FIG. 7 is a schematic illustration showing a force of the FMO to move the sled such that the waveform appears twice in the photo signal.

FIG. 8(a)˜8(c) is a schematic illustration showing the relative position between the sled and the optical pickup during the seeking process in the invention.

FIG. 9 is a flow chart showing a method of on-line adjusting the FMO during a shorting seeking process in the invention.

### DETAILED DESCRIPTION OF THE INVENTION

Typically, the sled is moved to make the optical pickup locate within its movable range according to the FMO when the optical disk drive is performing the short seeking process. However, because the difference between the static friction force and the dynamic friction force exerted on the sled is too great, the optical pickup after seeking is not within the movable range. In order to overcome the above-mentioned problem, the invention proposes a method of on-line adjusting the FMO during seeking.

The invention utilizes a photo signal to assist the method of on-line adjusting a FMO. The generation of the photo signal and its representative physical meaning will be described in the following.

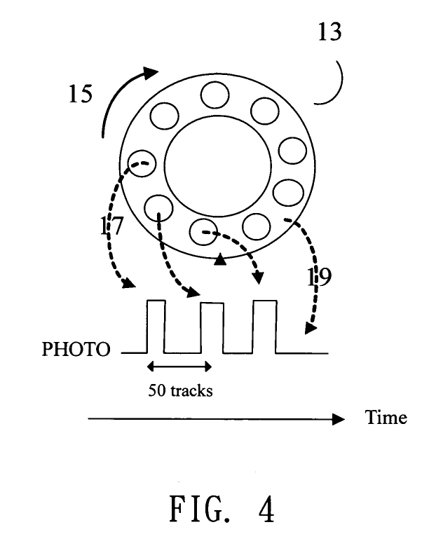

FIG. 4 is a schematic illustration showing a photo interrupt. When the optical disk drive is enabled, the photo interrupt 13 rotates in the direction 15. When the laser light reflected from the optical disk passes through the transparent region 17 of the photo interrupt 13, a waveform appears in the photo signal (PHOTO). Inversely, if the laser light passes through the opaque region 19 of the photo interrupt 13, no waveform appears in the photo signal. Because the rotating speed of the photo interrupt is fixed, the sled seeks 50 tracks during the interval between the generated waveforms in the photo signal, as shown in FIG. 4. Typically, the tracking error signal for calculating the seeking number represents that the optical pickup has sought one track after a period of waveform, which is greatly different from the photo signal representing that the sled has sought 50 tracks during a period of waveform. Thus, the photo signal is usually used to calculate the seeking number of the long seeking, but the tracking error signal is adopted to calculate the seeking number of the short seeking.

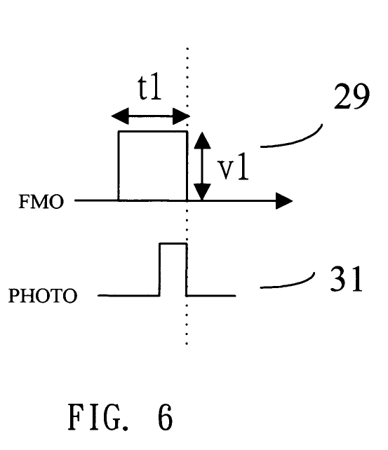

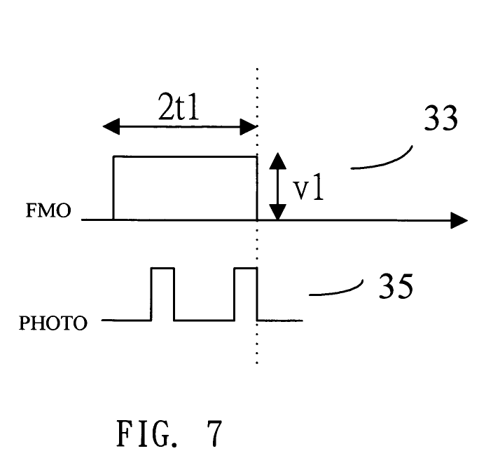

FIG. 6 is a schematic illustration showing a force of the FMO (v1,t1) 29 to move the sled such that the waveform appears once (i.e., the sled seeks 50 tracks) in the photo signal. If two waveforms have to appear in the photo signal during the seeking process, the duration of the FMO has to be doubled. That is, the FMO is changed to (v1,2t1), as shown in symbol 31 of FIG. 7.

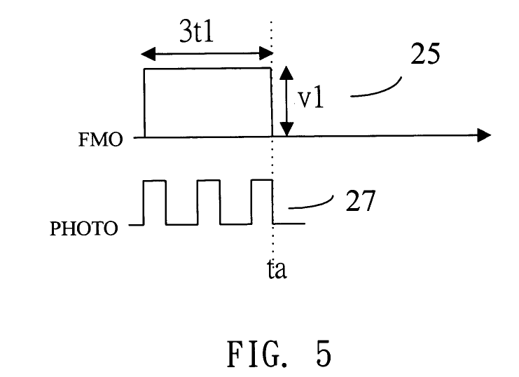

The example of the optical disk drive for seeking 200 tracks will be described with reference to FIG. 5. When the servo system outputs a command of seeking 200 tracks, the sled is caused to directly slide 150 tracks. That is, the FMO 25 is assumed to be (v1,3t1) to make the sled slide. The photo signal 27, in which the waveform appears thrice (i.e., 150 track is sought), is monitored. Because no force is applied to the sled 7 at time t1, the sled 7 gradually slows down and finally stops. At this time, the number of tracks from the optical pickup 3 to the target track is calculated. Then, the optical pickup is moved to seek the uncompleted number of tracks such that the optical pickup 3 is exactly at the center position of the sled 7 as it reaches the target track.

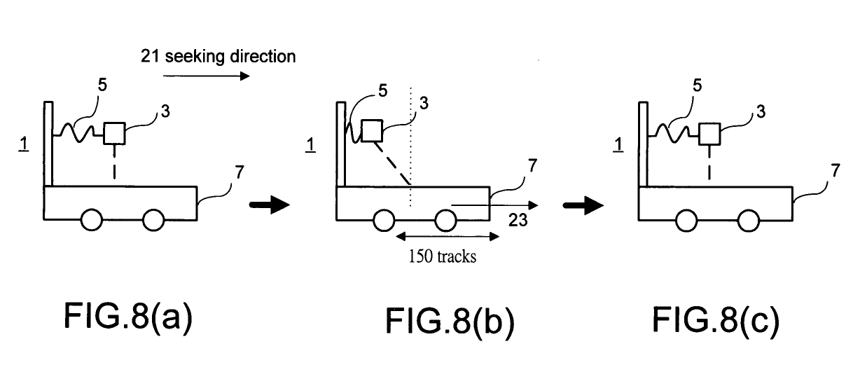

FIG. 8 is a schematic illustration showing an optical head module of the invention when 200 tracks are sought. At the beginning when the servo system outputs a command of seeking 200 tracks in the direction 21, the optical pickup 3 is at the center position of the sled 7, as shown in FIG. 8(a). The servo system directly assigns the FMO a bias to enable the sled 7 to slide in the direction 23. At this time, the optical pickup 3 is getting more and more deviated from the center position of the sled 7 owing to the inertial, as shown in FIG. 8(b). After three cycles have appeared in the photo signal (i.e., the sled has been moved 150 tracks), the FMO is immediately off, so no force is applied to the sled 7. The sled 7 gradually slows down and finally stops. Thereafter, the spring 5 is used to adjust the optical pickup 3 to finish the number of remaining tracks. Consequently, when the optical pickup 3 finishes the seeking of 200 tracks, its position is just located at the center position of the sled 7.

However, the friction forces are not the same and thus different resistance forces are caused owing to the tolerances and fittings between the movable components when the optical disk drive is manufactured in a mass production manner. The single fixed default FMO (v1,t1) is not suitable for all optical disk drives. So, the invention completes the method of on-line adjusting the FMO during the seeking process according to the photo signal.

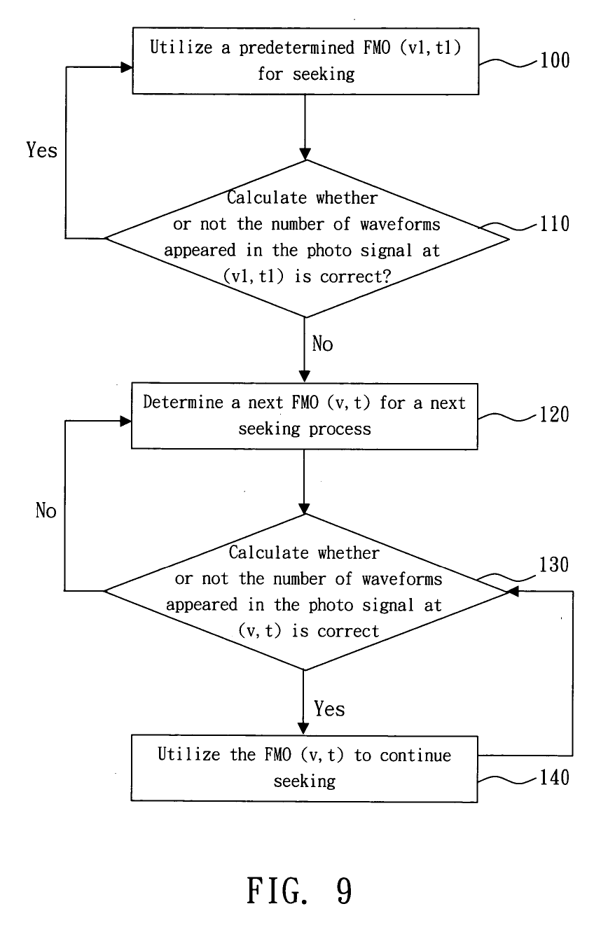

FIG. 9 is a flow chart showing a method of on-line adjusting the FMO during a shorting seeking process in the invention. The method will be described in the following.

In step 100, a predetermined FMO (v1,t1) is assigned to move a sled for seeking. The predetermined FMO (v1,t1) is the force for pushing the sled to make the waveform appears once in the photo signal (i.e., the sled seeks 50 tracks), as shown in symbol 29 of FIG. 6. If N waveforms have to appear in the photo signal during the seeking process, the duration of the FMO is lengthened N times.

In step 110, the number of waveforms appearing in the photo signal at (v1,t1) is calculated to determine whether or not the number is correct. If yes, the process goes back to step 100, and the FMO still adopts the previous default value (v1,t1). On the contrary, the process goes to step 120.

In step 120, a FMO (v,t) for the next seeking process is determined. The FMO to be corrected is determined according to the calculation result in step 110. If only 120 tracks are sought by the sled at (v1,3t1), it is known that the default FMO is too small, and the duration has to be lengthened to (v1,t1+Δt). On the contrary, the duration has to be shortened to (v1,t1−Δt).

In step 130, the number of waveforms appearing in the photo signal is calculated at (v,t) to determining whether or not the number is correct. If yes, it means that the corrected FMO (v,t) in step 120 is suitable, and the process goes to step 140; otherwise, the process goes back to step 120 for correction again.

In step 140, the seeking process continues according to the FMO (v,t), and the process goes back to step 130. That is, the corrected FMO detects whether or not the FMO (v,t) is suitable after each seeking process.

Therefore, the advantage of the invention is to utilize the existing hardware apparatus to achieve the position correction for the optical pickup after seeking. Therefore, it is possible to solve the problem that the optical pickup is out of its movable range after seeking owing to the great difference between the dynamic and static friction forces after the prior art seeking process.

Another advantage of the invention is to effectively shorten the required time for the track on operation. The invention firstly controls the FMO to move the sled by most of the tracks (coarse adjustment), and then utilizes the spring to finely adjust the position of the optical pickup. Compared to the prior art, which utilizes the spring to finely adjust the optical pickup to perform the short seeking, the invention is more precise. Thus, the optical pickup after seeking is located at the center position of the sled, which is quite advantageous to the following track on operation, and the required time for track on may be effectively shortened.

Still another advantage of the invention is that the FMO of on-line seeking is provided. When each seeking is performed, the servo system identifies whether or not the adopted FMO for seeking is suitable according to the photo signal. If not, the servo system corrects the FMO for seeking until the servo system gets the suitable FMO.

Of course, the invention is not limited to the only application of the short seeking because the long seeking and the short seeking are mixed during the seeking process and definitions of the long and short seeking processes are recognized by the firmware of the servo system. So, the above-mentioned invention is not restricted to the short seeking application of only several hundreds of tracks.

Furthermore, the FMO is corrected by adjusting the duration of the FMO in the above-mentioned embodiment. However, it is also possible to correct the FMO by adjusting the amplitude (i.e., v value) of the FMO, or by adjusting both the duration and the amplitude (i.e., v and t are adjusted).

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A method of on-line adjusting a sled motor control signal (FMO) in an optical disk drive during seeking, the method comprising the steps of:
assigning a predetermined FMO to move a sled for seeking and monitoring a photo signal; and determining a next FMO for a next seeking process according to the number of waveforms appeared in the photo signal.

2. The method according to claim 1, wherein when the number of waveforms is equal to a predetermined number, the next FMO in the next seeking process is equal to the predetermined FMO.

3. The method according to claim 1, wherein when the number of waveforms is not equal to a predetermined number, the next FMO in the next seeking process is obtained by adjusting an duration of the predetermined FMO.

4. The method according to claim 1, wherein when the number of waveforms is not equal to a predetermined number, the next FMO in the next seeking process is obtained by adjusting an amplitude of the predetermined FMO.

5. The method according to claim 1, wherein when the number of waveforms is not equal to a predetermined number, the next FMO in the next seeking process is obtained by adjusting both an duration and an amplitude of the predetermined FMO.

6. The method according to claim 1, wherein the photo signal is a signal generated with reflected light passes through a photo interrupt.

7. The method according to claim 1, wherein each time the waveform of the photo signal appears represents that the sled has moved a plurality of fixed number of tracks.

8. The method according to claim 1, wherein the FMO is a force voltage of the sled.

9. A method of on-line adjusting a FMO in an optical disk drive during seeking, the method comprising the steps of:
assigning a predetermined FMO to move a sled for seeking and monitoring a photo signal;
calculating the number of waveforms appeared in the photo signal and a distance from an optical pickup to a target track under the FMO; and
moving the optical pickup to the target track to make the optical pickup locate at a predetermined position.

10. The method according to claim 9, wherein when the number of waveforms is not equal to a predetermined number, an duration of the FMO is adjusted according to a comparison value between the number of waveforms and the predetermined number.

11. The method according to claim 9, wherein when the number of waveforms is not equal to a predetermined number, an amplitude of the FMO is adjusted according to a comparison value between the number of waveforms and the predetermined number.

12. The method according to claim 9, wherein when the number of waveforms is not equal to a predetermined number, an duration and an amplitude of the FMO are adjusted according to a comparison value between the number of waveforms and the predetermined number.

13. The method according to claim 9, wherein the predetermined number is determined according to a seeking distance.

14. The method according to claim 9, wherein the photo signal is a signal generated with reflected light passes through a photo interrupt.

15. The method according to claim 9, wherein each time the waveform of the photo signal appears represents that the sled has moved a plurality of fixed number of tracks.

16. The method according to claim 9, wherein the predetermined position is a center position, at which the optical pickup is located, in a movable range of the sled.

17. The method according to claim 9, wherein the FMO is a force voltage of the sled.
